(19) United States
(12) Patent Application Publication
(10) Pub. No.: US 2012/0242487 A1
(43) Pub. Date: Sep. 27, 2012

(54) ELECTRONIC DEVICE WITH HIGH TEMPERATURE ALARM FUNCTION

(75) Inventor: YONG-ZHAO HUANG, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/095,951

(22) Filed: Apr. 28, 2011

(30) Foreign Application Priority Data
Mar. 22, 2011 (CN) 201110069208.5

(51) Int. Cl. G08B 17/00

(52) U.S. Cl. 340/584

(57) ABSTRACT

An electronic device includes a power unit, an alarm, a silicon-controlled rectifier (SCR), a thermo-sensor, a variable resistor, and a zener diode. The variable resistor is connected to the thermo-sensor in series between the power unit and ground. A first input terminal of the comparator is connected to a node between the thermistor and the variable resistor. A second input terminal of the comparator is connected to a node between the zener diode and the first resistor to receive a reference voltage. An output terminal of the comparator is connected to a control terminal of the SCR. When a temperature of the electronic device is higher than a predetermined temperature, the comparator turns on the SCR to activate the alarm. When the temperature of the electronic device is lower than the predetermined temperature, the comparator turns off the SCR and the alarm turns off.

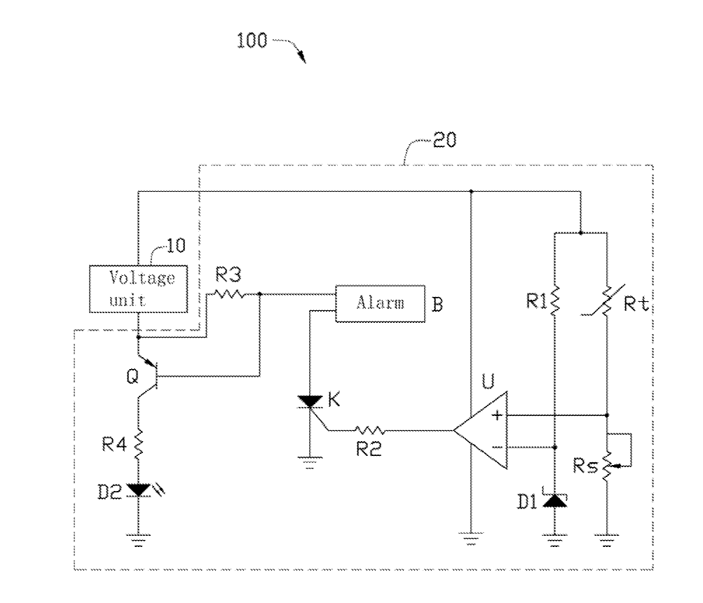

### BACKGROUND

1. Technical Field

The present disclosure relates to electronic devices, and particularly, to an electronic device that has high temperature alarm function.

2. Description of Related Art

Most electronic components must operate within a certain temperature range. When the temperature of an electronic component is lower or higher than a specified temperature range, the electronic component may malfunction. Therefore, effective temperature control is imperative for the proper functioning of many electronic components.

### BRIEF DESCRIPTION OF THE DRAWING

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

The drawing is a circuit diagram of an exemplary embodiment of an electronic device with high temperature alarm function.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

Referring to the drawing, an exemplary embodiment of an electronic device 100 with high temperature alarm function includes a power unit 10 and a high temperature alarm circuit 20. The power unit 10 is connected to the high temperature alarm circuit 20, to supply a work voltage to the high temperature alarm circuit 20.

The high temperature alarm circuit 20 includes a comparator U, a zener diode D1, a first electrical switch, such as a silicon-controlled rectifier (SCR) K, a variable resistor Rs, a thermo-sensor such as a thermistor Rt, a transistor Q, resistors R1-R4, a light emitting diode (LED) D2, and an alarm B. The thermistor Rt and the variable resistor Rs are connected in series between the power unit 10 and ground. An anode of the zener diode D1 is grounded. A cathode of the zener diode D1 is connected to the power unit 10 through the resistor R1. A non-inverting terminal of the comparator U is connected to a node between the thermistor Rt and the variable resistor Rs. An inverting terminal of the comparator U is connected to a node between the zener diode D1 and the resistor R1. An output terminal of the comparator U is connected to a control terminal of the SCR K through the resistor R2. A power terminal of the comparator U is connected to the power unit 10. A ground terminal of the comparator U is grounded. An anode of the SCR K is connected to a first terminal of the alarm B. A cathode of the SCR K is grounded. A second terminal of the alarm B is connected to a base of the transistor Q. The base of the transistor Q is connected to an emitter of the transistor Q through the resistor R3. The emitter of the transistor Q1 is connected to the power unit 10. A collector of the transistor Q is connected to an anode of the LED D2 through the resistor R4. A cathode of the LED D2 is grounded.

In the embodiment, the zener diode D1 and the resistor R1 make up a voltage divider to divide a direct current (DC) voltage from the power unit 10 and output a reference voltage to the inverting terminal of the comparator U. The resistance of the thermistor Rt increases when the temperature of the thermistor Rt decreases, and decreases when the temperature of the thermistor Rt increases. The high temperature alarm circuit 20 is used to activate the alarm B and turn on the LED D2 when a temperature of the electronic device 100 exceeds a predetermined temperature, such as 40 degrees Celsius. According to the resistance of the thermistor Rt at 40° C., the resistance of the variable resistor Rs is adjusted to make a voltage at a node between the variable resistor Rs and the thermistor Rt greater than the reference voltage.

When the electronic device 100 is in a normal state, the temperature of the electronic device is less than or equal to 40° C., and the resistance of the thermistor Rt is greater than the resistance of the thermistor Rt when the thermistor Rt is at 40° C. The voltage of the non-inverting terminal of the comparator U is less than the reference voltage at the inverting terminal of the comparator U. The output terminal of the comparator U outputs a low level voltage to the control terminal of the SCR K. The SCR K is turned off, and the alarm B and the LED D2 stay off.

When the temperature of the electronic device 100 is higher than 40° C., the resistance of the thermistor Rt is less than the resistance of the thermistor Rt when the thermistor Rt at 40° C. or below. The voltage of the non-inverting terminal of the comparator U is higher than the reference voltage at the inverting terminal of the comparator U. The output terminal of the comparator U outputs a high level voltage to the control terminal of the SCR K. The SCR K is turned on, and the alarm B is activated and the LED D2 is turned on.

In the embodiment, the transistor Q is a pnp transistor. In other embodiments, the transistor can be an npn transistor, and a base of the npn transistor is connected to the power unit 10. An emitter of the npn transistor is connected to the anode of the alarm through the resistor R4. A collector of the npn transistor is connected to the base of the npn transistor through the resistor R3.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An electronic device with high temperature alarm function, the electronic device comprising:
a power unit; and
a high temperature alarm circuit connected to the power unit, the high temperature alarm circuit comprising:
an alarm;
a silicon-controlled rectifier (SCR) comprising an anode connected to the power unit through the alarm, a cathode grounded, and a control terminal;
a thermo-sensor to sense a temperature of the electronic device;
a variable resistor connected to the thermo-sensor in series between the power unit and ground; and
a zener diode comprising an anode grounded and a cathode connected to the power unit through a first resistor; and
a comparator comprising a first input terminal connected to a node between the thermo-sensor and the variable resistor, a second input terminal connected to a node between the zener diode and the first resistor to receive a reference voltage, and an output terminal connected to the control terminal of the SCR;
wherein when a temperature of the electronic device is higher than a predetermined temperature, the output terminal of the comparator outputs a first control signal to turn on the SCR to activate the alarm, when the temperature of the electronic device is less than or equal to the predetermined temperature, the comparator outputs a second control signal to turn off the SCR and the alarm turns off.

2. The electronic device of claim 1, wherein the thermo-sensor is a thermistor, a resistance of the thermistor increases when a temperature of the thermistor decreases, the resistance of the thermistor decreases when the temperature of the thermistor increases, the thermistor is connected between a non-inverting terminal of the comparator and the power unit, an inverting terminal of the comparator is connected between the zener diode and the first resistor, the first control signal is a high level voltage, the second control signal is a low level voltage.

3. The electronic device of claim 1, further comprising a light emitting diode (LED), a transistor, and a second resistor, wherein the anode of the SCR is connected to a negative voltage terminal of the alarm, a positive voltage terminal of the alarm is connected to the power unit through the second resistor, and connected to a control terminal of the transistor, a first terminal of the transistor is connected to an anode of the LED, a cathode of the LED is grounded, a second terminal of the transistor is connected to the power unit, when the SCR is turned on, the transistor is turned on, the LED is turned on, when the SCR is turned off, the transistor is turned off, the LED stay off.

4. The electronic device of claim 3, wherein the transistor is a pnp transistor, the control terminal, the first terminal, the second terminal of the transistor are respectively a base, a collector, and an emitter of the pnp transistor.
